(19) United States
(12) Patent Application Publication
(10) Pub. No.: US 2026/0072658 A1
(43) Pub. Date: Mar. 12, 2026

(54) DISTRIBUTED CODE GENERATION FOR VISION APPLICATIONS

(71) Applicant: NEC Laboratories America, Inc., Princeton, NJ (US)

(72) Inventors: Kunal Rao, Monroe, NJ (US); Giuseppe Coviello, Robbinsville, NJ (US); Srimat Chakradhar, Manalapan, NJ (US)

(21) Appl. No.: 19/317,368

(22) Filed: Sep. 3, 2025

Related U.S. Application Data
(60) Provisional application No. 63/693,357, filed on Sep. 11, 2024.

(51) Int. Cl. G06F 8/41

(52) U.S. Cl. CPC G06F 8/433; G06F 8/436

(57) ABSTRACT

Systems and methods for generating and executing distributed code. The systems and methods include receiving serial code generated by a large language model (LLM) for vision applications and analyzing the serial code with a trained model to identify code dependencies and detect independent application programming interface (API) calls. The systems and methods further include transforming the serial code by incorporating program semantics that enable concurrent execution of the independent API calls and generating distributed code configured for execution on a container orchestration platform cluster, wherein the distributed code includes service calls that can be understood and executed by a runtime system.

### RELATED APPLICATION INFORMATION

This application claims priority to U.S. Provisional Patent Application No. 63/693,357, filed on Sep. 11, 2024, incorporated herein by reference in its entirety.

### BACKGROUND

### Technical Field

The present invention relates to generative artificial intelligence and more particularly generating computer code for vision applications.

### Description of the Related Art

Large Language Models (LLMs) have the potential to generate software. Consequently, attention has moved towards using LLMs in building complex software to alleviate and subsume some of the costs involved in software development and deployment. Current implementations of LLM code generation only focus on serial (monolithic) code generation, however. This means the code can only be executed on a single computing device which limits the applicability of LLM code generation, especially in artificial intelligence (AI) applications because of the varying hardware configurations executing the generated code.

### SUMMARY

According to an aspect of the present invention, a method is provided for generating and executing distributed code. The method includes receiving serial code generated by a large language model (LLM) for vision applications and analyzing the serial code with a trained model to identify code dependencies and detect independent application programming interface (API) calls. The method further includes transforming the serial code by incorporating program semantics that enable concurrent execution of the independent API calls and generating distributed code configured for execution on a container orchestration platform cluster, wherein the distributed code includes service calls that can be understood and executed by a runtime system.

According to another aspect of the present invention, a system is provided for generating and executing distributed code. The system includes a processor and a memory storing computer-readable instructions. The memory causes the processor to receive serial code generated by a LLM for vision applications and analyze the serial code with a trained model to identify code dependencies and detect independent API calls. The memory further causes the processor to transform the serial code by incorporating program semantics that enable concurrent execution of the independent API calls and generate distributed code configured for execution on a container orchestration platform cluster, wherein the distributed code includes service calls that can be understood and executed by a runtime system.

According to yet another aspect of the present invention, a computer program product is provided for generating and executing distributed code. The computer program product includes computer program code that when executed by one or more processors causes one or more processors to perform operations. The computer program product includes instructions to receive serial code generated by a LLM for vision applications and analyze the serial code with a trained model to identify code dependencies and detect independent API calls. The computer program product also includes instructions to transform the serial code by incorporating program semantics that enable concurrent execution of the independent API calls and generate distributed code configured for execution on a container orchestration platform cluster, wherein the distributed code includes service calls that can be understood and executed by a runtime system.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating an application of the distributed code generation and execution, in accordance with an embodiment of the present invention;

FIG. 2 is a block diagram illustrating a high-level system for code generation and execution, in accordance with an embodiment of the present invention;

FIG. 3 is a block diagram illustrating a system for training a Large Language Model (LLM) code generator, in accordance with an embodiment of the present invention;

FIG. 4 is a block diagram illustrating a system for refining a system prompt for LLM code generation, in accordance with an embodiment of the present invention;

FIG. 5 is a block diagram illustrating a system for generating distributed code, in accordance with an embodiment of the present invention;

FIG. 6 is a block diagram illustrating execution of distributed code, in accordance with an embodiment of the present invention;

FIG. 7 is a flow diagram illustrating an algorithm for training the model to generated distributed code, in accordance with an embodiment of the present invention;

FIG. 8 is a block diagram illustrating serial code, in accordance with an embodiment of the present invention;

FIG. 9 is a block diagram illustrating parallel version of the serial code, in accordance with an embodiments of the present invention;

FIG. 10 is a flow diagram illustrating a method for generating and distributing serial code in parallel, in accordance with an embodiments of the present invention;

FIGS. 11-12 are block diagrams illustrating embodiments of the present invention, in accordance with an embodiments of the present invention;

FIG. 13 is a block diagram illustrating a system for generating and executing distributed code, in accordance with an embodiment of the present invention; and

FIG. 14 is a block diagram illustrating an artificial neural network for employing LLMs, in accordance with an embodiment of the present invention.

### DETAILED DESCRIPTION OF PREFERRED EMBODIMENTS

Embodiments of the present invention can include a large language model (LLM) based tool which automatically generates a distributed version of code and a component that understands the program semantics and executes independent tasks within the program on a cluster of computing devices. Other solutions to optimize LLM generated code have attempted to generate parallel code but focus on low-level parallelization such as optimizing for multiple cores or unique characteristics of the central processing units (CPU) or graphics processing unit (GPU) architecture. Embodiments of the present invention take advantage of multiple computing devices, each having GPUs to distribute execution of code. Though use of multiple computing devices is not necessary.

In an embodiment of the present invention, the computing devices can be clusters, computers, edge devices, internet of things (IoT) devices, servers, setups, machines, etc. Each computing device can be a GPU, CPU, tensor processing unit (TPU), neural processing unit (NPU), other application specific integrated circuit (ASIC), field programmable gate array (FPGA), etc., or any combination thereof. The specific hardware that the computing device is housed on can be located at a single location or at several locations or a combination thereof.

In embodiments of the present invention, the LLM-based tool analyzes dependencies in the serial code and evaluates whether there are opportunities to implement the same tasks in parallel. Once these opportunities are discovered, the code is marked with semantics so that the code can be performed on several computing devices. In other words, the program can have one set of processes performed on a different device than other processes and the devices know which portion to execute based on indications in the code.

For example, an Application Programming Interface (API) and other finer granularity/low-level compiler optimization techniques, e.g., vectorization, loop unrolling, instruction level parallelism, etc. can improve computational efficiency. The processes can be performed on separate pieces of hardware (e.g., devices). Each API call is considered as a task, and the LLM-based tool transforms the code such that independent tasks can be distributed and run in parallel, as opposed to sequentially, which is what occurs when serial code is performed (and the code is performed on a single piece of hardware).

The distributed version of the code generated by the LLM-based tool follows specific program semantics, which can be understood by an underlying runtime. Once the distributed code is generated by the LLM-based tool, the runtime component understands the program semantics and efficiently executes independent tasks within the program on a distributed computing devices in the proper order.

In an embodiment of the present invention, an artificial intelligence (AI) model being trained or executed on a cluster of computing devices can apply parallel tasks well and is suitable for using distributed code generation. AI models often compute the same type of calculation many times and can utilize GPUs because GPUs are designed to process the same task many times and can be stored on several different computing devices. This may be more efficient than performing the same task on a single computing device which may use a CPU instead, which is less efficient at performing the same task repetitively.

AI models can perform any number of tasks such as image classification, object detection, segmentation, pose estimation, speech recognition, speaker identification, sound event detection, named entity recognition, sentiment analysis, semantic similarity, text generation, code generation, machine translation, summarization, image synthesis, video generation, text to speech, music generation, game-playing, robotics control, route optimization, multi-agent coordination, symbolic reasoning, theorem proving, multi-hop question answering (QA), commonsense reasoning, recommender systems, dialogue agents, personal assistants, adaptive learning systems, anomaly detection, time series forecasting, clustering/classification/regression, feature selection and dimensionality reduction, etc. This is not intended to be limiting, and this list is non-exclusive.

In some embodiments of the present invention, code generation can be associated with Synthia and code execution can be associated with Hermod.

Embodiments of the present invention can enter prompts into a trained model, e.g., a generative artificial intelligence (GenAI) model which can generate code to perform tasks reflected in the prompt. The code can be distributed on a computing device or group of computing devices to perform the code in a distributed fashion. The GenAI model can form serial code from the prompt then a distributed version of the serial code. The distributed version of the serial code can be parsed into functions based on dependencies within the code. Each instance of the function can be treated separately and distributed on different computing devices. In other words, the functions in the code can be distributed to reduce computing device downtime. This can maximize throughput. In other embodiments of the present invention, latency can be minimized. The balance between throughput and latency can be dependent on the amount of data being processed.

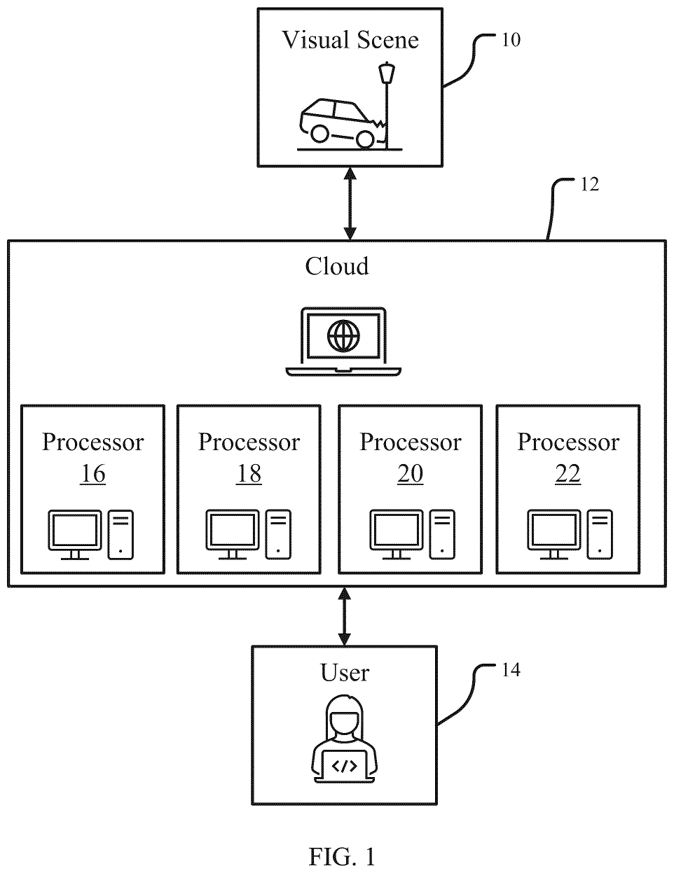

Referring now in detail to the figures in which like numerals represent the same or similar elements, and initially to FIG. 1, a block diagram for employing distributed code for visual applications is demonstrated. A user 14 can interact with a cloud 12 environment to process information related to visual scene 10. Cloud 12 can include GPUs, CPUs, AI models, memory, networking/communication/transmission capabilities, software, databases, etc. The GenAI models can include LLMs, VLMs, other generative artificial intelligence models, other artificial neural networks (ANNs), etc.

Cloud 12 can receive a prompt from user 14. The prompt can request some information from visual scene 10. For example, user 14 can request information about a car crash such as, e.g., “how many cars were involved,” “what types of cars were involved,” “how much damage was there,” “can you see any personal identification information,” etc.

From these prompts, cloud 12 can indicate portions of the code to perform these tasks on separate computing devices. The code can be parsed according to tasks, functions, programs, procedures, methods, routines, operations, jobs, processes, threads, services, etc. Based on how the code is parsed, the code can be allocated to different computing devices to perform portions of the code in parallel. In some embodiments of the present invention the parsed code can divided so that each parsed portion is assigned to a computing device. In other embodiments of the present invention, the parsed portion of the code can be assigned to be optimized for execution the code as a whole (e.g., throughput), rather than each individual function (e.g., latency). To put this another way the code can be optimized for the throughput of the code as a whole by assigning the code so that the most code is processed the fastest, rather than the latency of each individual function. Cloud 12 can be adaptive at assigning the code based on the amount of data to be processed and other considerations. Reinforcement learning can be applied to adapt the code for a given purpose, such as throughput, though other characteristics to optimize the code are contemplated.

While on one image of visual scene 10 is depicted, in other embodiments of the present invention, several images can be processed simultaneously or concurrently. Based on the number of images and the functions required to process the code reflecting the request in the prompt, cloud 12 can allocate the functions to processors differently. Some portions of the code can take more time to process than others meaning that allocating portions of the code to a single computing device can have some computing devices with unnecessary down time. Embodiments of the present invention reduce or eliminate this down time.

Processor 16 can process one portion of the code e.g., “how many cars were involved.” Processor 18 can process one portion of the code e.g., “what types of cars were involved.” Processor 20 can process one portion of the code e.g., “how much damage was there.” Processor 22 can process one portion of the code e.g., “can you see any personal identification information.”

Processors 16-24 can include computing devices, e.g., GPUs, CPUs, etc. If the processing for the portion of the code on processor 16 is less intensive, e.g., has a shorter runtime, than the processing on processor 20, then processor 16 can be assigned some of the processing that would otherwise be allocated to processor 20. For example, if there are several images of visual scene 10, processor 16 can process all of the images for “how many cars were involved” and one or two images of “how much damage was there.” This can aid in maximizing throughput.

The prompts can be input concurrently and if so, the code is assigned at runtime since the computing device memory and processing power for each prompt is not known previously. This makes optimal configuration difficult or impossible without embodiments of the present invention. Further, during execution, different APIs are called one after the other, with some CPU processing in between. The computing devices are idle during CPU processing, and even when the computing devices are used, a single AI model execution may not fully utilize the computing devices, especially when a large computing device is requested to fit several small and large AI models, and most of the time is spent in running the small models. Such under-utilization of computing device resources degrades overall application performance. Embodiments of the present invention can maximize and optimize computing device utilization.

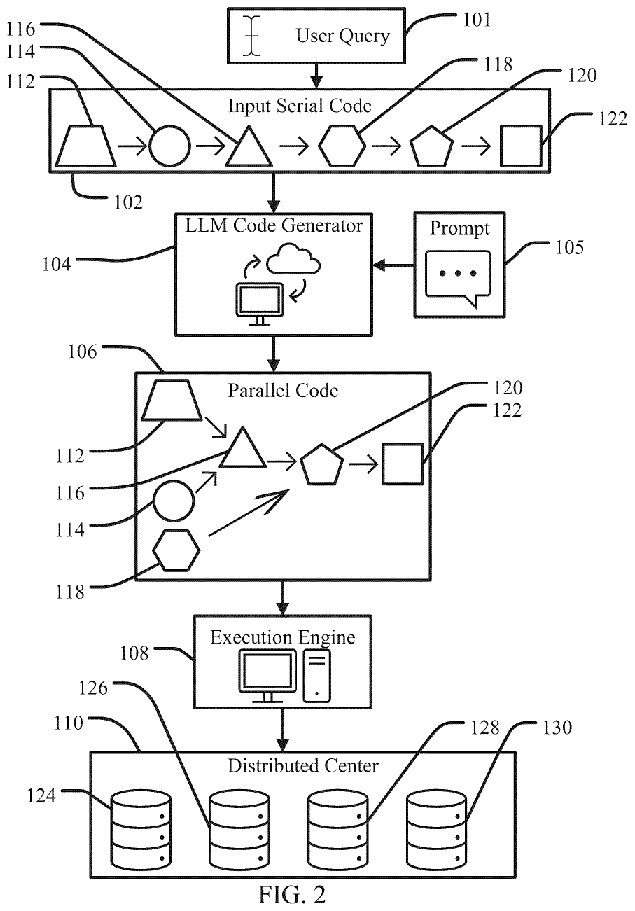

Referring to FIG. 2, a high-level architecture of the code generation framework is illustrated. The LLM-based tool can be an LLM code generator 104 which focuses on improving the performance of the input serial code 102. Performance of the input serial code 102 can be defined as the time taken to execute the code and generate an output (e.g., latency of code execution).

LLM code generator 104 can leverage concepts from parallel processing and generate distributed code which decomposes input serial code 102 into parallel tasks that can be performed on different computing devices most effectively. The parallel tasks that were in originally input serial code 102 can then be executed concurrently or at least partially concurrently on a cluster of computing devices, though they can be performed serially on different computing devices. In other words, embodiments of the present invention have more of an effect on high-level algorithmic improvements than actual implementation of the code itself (e.g., low-level algorithmic improvements). This improves the functioning of a computer by separating tasks. In situations where the network is made up of different types of GPUs made for different purposes, the distributed code can be generated to consider this can allocate GPU to tasks accordingly.

LLM code generator 104 uses a parallel computation model for execution on multiple computing devices rather than serial code execution, which occurs on a single computing device. This is because a distributed cluster 110 that performs parallel code 106 can be tasked with performing the same portion of the functions of the code many times (instead of all the functions in the code) such as training a neural network. GPUs are optimized for performing the same task instead of a variety of tasks, and there are efficiencies in economies of scale over performing input serial code 102 with CPUs, making parallel computing with GPUs preferable to serial computing.

LLM code generator 104 leverages generative artificial intelligence (GenAI) and LLMs to automatically generate distributed version of input serial code 102 according to a user query 101. User queries 101 and prompts 105 can be natural language inputs, images, videos, audio, or another types of input that the LLM is capable of processing. User query 101 is the desired goal in non-technical terms (though user query 101 can be in technical terms if preferred), while prompt 105 is machine generated input to an AI model to generate parallel code 106.

LLM code generator 104 includes an LLM which is trained to automatically transform input serial code 102 into parallel (distributed) code 106 which can be executed on distributed cluster 110. Input serial code 102 can be generated by any number of LLMs.

Input serial code 102 and parallel code 106 can be written in any number of computer languages including C/C++, Python, Java, JavaScript/TypeScript, C#, Go, Rust, Swift, Kotlin, Ruby, PHP, Perl, SQL, etc. Other languages are also contemplated, and this list is intended to be illustrative and non-limiting.

To execute tasks on separate computing devices, the LLM code generator 104 uses special program semantics, which use function calls to “services” on the component. The program semantics indicate which section of the code can be executed on a given computing device, separate from the others. The component can be an execution engine 108. Execution engine 108 can receive and execute parallel code 106 on distributed cluster 110. Through function calls, independent tasks can be executed in parallel on distributed cluster 110. The function calls can be independent API calls. This allows for dynamic, flexible, and adaptable code execution systems. For example, computing devices can be called for certain tasks or functions and otherwise available for other functions. In other words, the computing devices can be pooled such that they can be called by different entities performing different tasks. These computing devices can be employed when there is code to execute and be on standby otherwise so that other entities can perform other functions with the same computing devices at a later time or concurrently. Alternatively, depending on other system factors different computing devices can be employed to perform the same task. To put this another way, e.g., if a computing device is preferred to execute a certain function but is allocated to another, unrelated task or function, a different computing device can be assigned to perform the given function, rather than waiting for the preferred computing device.

In one embodiment of the present invention the code can be generated and executed in Python programing language and use the “asyncio” library to execute code concurrently. Other methodologies and similar or equivalent libraries in other languages are also contemplated such as, e.g., Trio, Curio, Twisted, Tokio, etc.

Generally, LLMs require proper guidance through prompts 105 to achieve the desired results. In some embodiments of the present invention, prompt 105 can be engineered to form parallel code 106 that can be executed in parallel by forming specific signals in the code to perform selected functions or portions of the code concurrently. Parallel code 106 is formed from prompt 105 and input serial code 102 while user query 101 is used to form input serial code 102. These signals can be functions from a module in the programming language that allows code to be executed concurrently. Other signals are also contemplated.

In embodiments of the present invention, user query 101 is intended to denote the input that derives input serial code 102 and prompts 105 are inputs to LLM code generator 104 that derive parallel code 106. Since LLMs are quite sensitive to prompt 105 (and user query 101), rather than manually writing prompt 105, a training phase in LLM code generator 104 automatically generates a system prompt 105. System prompt 105 will guide the LLM to generate syntactically correct and performant distributed code for the given input serial code 102 (while ensuring that parallel code 106 performs the same functions as input serial code 102). Syntactically correct can mean that the program syntax can be correct and the program can run. Performant can mean the code can take advantage of the parallelism in the distributed code and run faster than the serial version.

The tasks performed in input serial code 102 and parallel code 106 are illustrated as shapes in sequential order. In input serial code 102 the first function to be performed is a trapezoid 112, then a circle 114, then a triangle 116, then a hexagon 118, then a pentagon 120, and then a square 122. This linear process can be separated onto several different computing devices to make the code more efficient through parallel processing. Instead, trapezoid 112, circle 114, and hexagon 118 can be performed at the same time (in parallel) on different computing devices which can reduce the execution time of the code. Further, these computing devices can be configured to optimize each process on them through the selection of specific hardware or other means Computing devices can be configured and optimized to serve specific API calls.

Trapezoid 112 can embody code such as, e.g., defining variables, etc. Circle 114 can perform other operations concurrently with trapezoid 112, such as, e.g., importing modules. Triangle 116 can then execute the function defined using the variables from trapezoid 112 and a module from circle 114. While trapezoid 112 and circle 114 are being performed, hexagon 118 can also be performed concurrently since there is no dependency on hexagon 118 from triangle 116. The output from triangle 116 and hexagon 118 can then be combined in pentagon 120. The output from pentagon 120 can then be displayed graphically or returned in square 122.

In an exemplary embodiment of the present invention, execution engine 108 can use four servers, server one 124, server two 126, server three 128, and server four 130. While three actions at most can be performed at one in the code illustrated in FIG. 2, an additional server may be present to supervise the other servers, perform other tasks, provide redundancy, or otherwise be used. Server one 124 can perform the function described in trapezoid 112 while server two 126 can perform the function described in circle 114 and server three 128 can perform the function described in hexagon 118. In alternative embodiments of the present invention, the servers can be optimized for a given task or can perform the next task in the sequence.

To be clear, embodiments of the present invention can be integrated with low-level optimization of the code which make each of the functions represented by the shapes more efficient. Embodiments of the present invention change when and where the code is executed (e.g., concurrently on different machines), not but not the manner in which the code is executed, which can be improved by other techniques in conjunction to those mentioned herein.

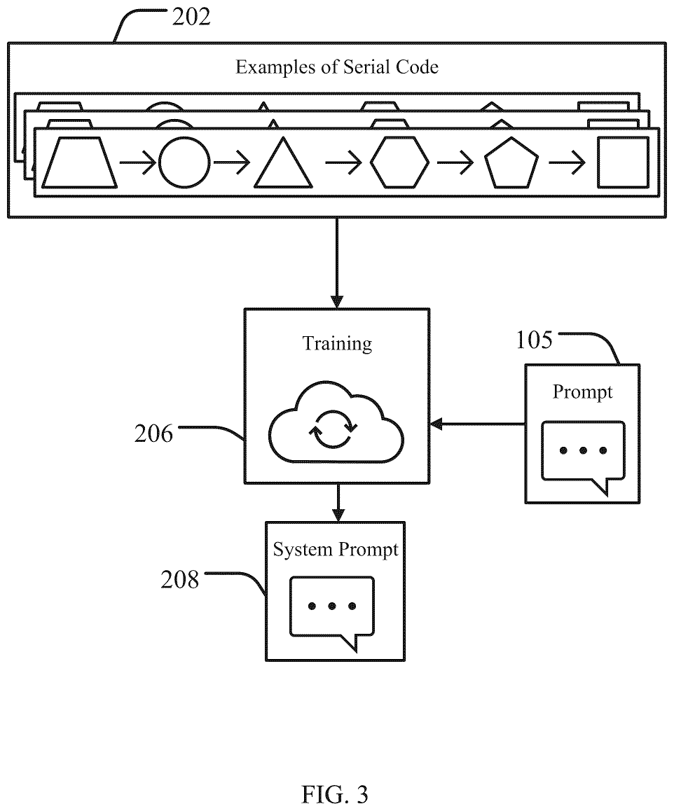

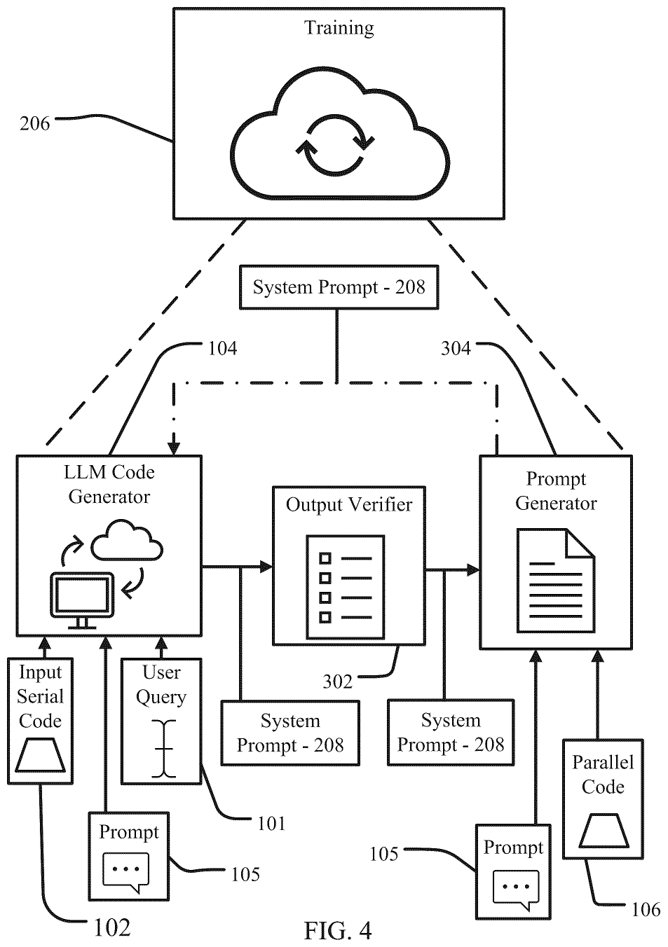

Referring to FIGS. 3 and 4, block diagrams of the training of LLM code generator 104 are illustrated in greater detail. The goal of training phase 206 is to derive a system prompt 208 which, given input serial code 102 and prompt 105, generates syntactically correct and performant parallel code 106 (FIG. 2), which can be executed on a distributed cluster 110 (FIG. 2). Input to training phase 206 includes several example serial codes 202 along with corresponding prompt 105 for which there is a known ground truth output. The known ground truth is the generated output from the serial code which can be compared with the output from the generated distributed code.

Training phase 206 is started with a basic seed prompt (prompt 105) and iteratively revises prompt 105 automatically until syntactically correct and performant versions of the parallel code 106 (FIG. 2) are generated. Parallel code 106 (FIG. 2) can perform the same functions as the equivalent code in the several examples of serial code 202 and do so faster. Embodiments of the present invention maintain the accuracy and functionality of several examples of serial codes 202 while improving the code by reducing runtime (e.g., making the runtime faster). In other words, parallel code 106 has no functionality, operability, or other degradation in code quality (to a reasonable, predetermined degree, if at all).

To implement training phase 206, a plurality of different LLMs (e.g., three) can be employed. LLM code generator 104 generates distributed code for user query 101 and several example serial codes 202 based on prompt 105. During training phase 206, the prompt 105 for LLM code generator 104 continues to be revised. Revision occurs whenever prompt 105 cannot generate syntactically correct and performant parallel code 106 (FIG. 2).

Another LLM used is output verifier 302 which compares an output for a given system prompt 208 in several example serial codes 202 with an output for a given system prompt 208 in parallel code 106 (FIG. 2) and determines whether they match. If prompt 208 matches, then system prompt 105 for LLM code generator 104 stays constant, if not, another LLM is invoked to revise prompt 105.

A different LLM used during training phase 206 can include prompt generator 304 which refines prompt 105 for LLM code generator 104 whenever the generated distributed code does not pass the standards of output verifier 302. Input to prompt generator 304 can include prompt 105, incorrect parallel code 106, and output from the serial and distributed code execution (system prompt 208). With these inputs, prompt generator 304 analyses the reason prompt 105 was not able to generate a satisfactory version of parallel code 106 and then derives a new system prompt 208, which matches input serial code 102 better. Once training phase 206 is complete, LLM code generator 104 and prompt 105 are aligned to automatically generate parallel code 106.

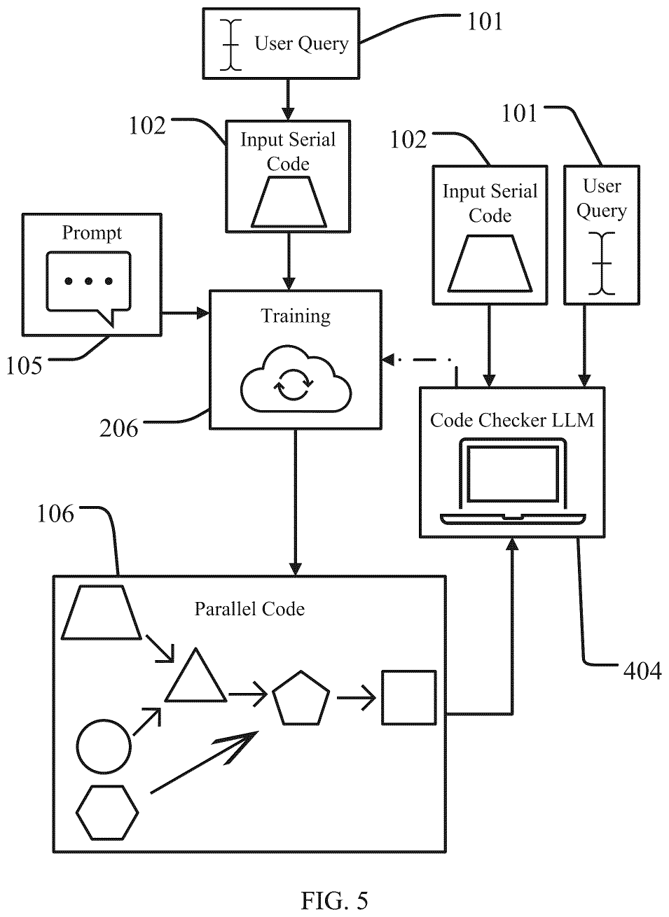

Referring to FIG. 5, a block diagram for inference generation of the LLM-based tool is illustrated. Once parallel code 106 is generated, the code is tested to determine whether the code is suitable for deployment or other use. To validate the performance of parallel code 106 another LLM is used. Code checker LLM 404 has as inputs user query 101, input serial code 102, and parallel code 106. With these inputs, code checker LLM 404 compares the two codes and determines whether parallel code 106 can generate the same output as input serial code 102. If the code passes, then the suggested parallel code 106 is given as the final output. If not, then another version of parallel code 106 is generated and compared. This continues until a suggested parallel code 106 version passes.

In further detail, several serial code 102 examples are executed to achieve output for verification purposes. For each input serial code 102, a corresponding parallel code 106 is also generated, with a corresponding output. Then, the two outputs are compared. If parallel code 106 is faster than the input serial code 102 (performant) and the outputs match, then the next input serial code 102 example is tested. If not, then a new prompt 105 is generated and applied to LLM code generator 104. The failed test is repeated until a configured maximum number of attempts to determine if the test is passed, e.g., generated parallel code 106 is performant and the output matches input serial code 102. Whenever a previously failed test passes, the process is repeated from the beginning to ensure that the refined system prompt 105 has not changed behavior for previously passed tests. This process continues until all tests pass for a minimum configured number of times. Once completed, the last system prompt 105 is used as the final instructions.

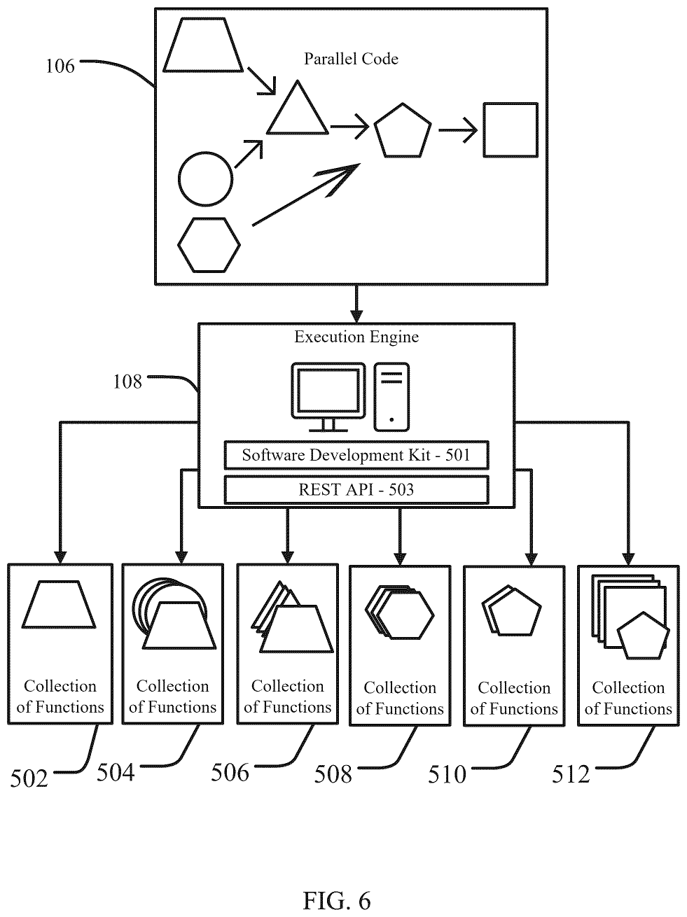

Now referring to FIG. 6, execution engine 108 is described in further detail. While LLM code generator 104 (FIG. 2) automatically generates a distributed version of input serial code 102 (FIG. 2) to improve code performance, execution engine 108 focuses on efficient execution of the generated parallel code 106 on a set of distributed computing devices, e.g., cluster of computer devices (distributed cluster 110). Input to execution engine 108 is the parallel code 106 generated by LLM code generator 104.

Since LLM code generator 104 is aware of the underlying runtime, parallel code 106 already incorporates special program semantics to invoke function calls to “services” on execution engine 108. These function calls are understood by execution engine 108 and executed efficiently on the underlying distributed infrastructure (e.g., distributed cluster 110). These function calls are indications in parallel code 106 that separate the code into different computing devices. In other words, the function calls are indicators in the code that reflect when parallel operations can be performed. In some embodiments of the present invention. programming language libraries can be imported into the code and have functions to indicate which functions can be performed concurrently.

In some embodiments of the present invention, execution engine 108 can be paired with third-party solutions, such as, e.g., Kubernetes, though third-party solutions are not necessary. The third-party solutions can be container orchestration frameworks that act as an “operator” to package, deploy, and manage Kubernetes applications. The operator exposes a new “kind” called “function,” through which various functions as a “service” can be deployed on the third-party solution. The “kind” is installed in Kubernetes to create clusters using docker container nodes. The “service” exposes a set of pods as a network service. These functions are stateless and serverless since execution engine 108 manages the computing devices and is transparent to the source writing or function invoking.

Various functions can be deployed on execution engine 108, each performing a specific task (e.g., portion of parallel code 106 that is on a separate computing device). Each function forms a “deployment” and execution engine 108 creates multiple copies/instances of each function and executes them as “pods” within the third-party solution. There are several ways to invoke a function that runs on execution engine 108. For example, several copies of the function represented by trapezoid 112 can form collection of functions 502. A collection of functions 504 can be for circle 114, a collection of functions 506 can be for triangle 116, a collection of functions 508 can be for hexagon 118, a collection of functions 510 can be for pentagon 120, and a collection of functions 512 can be for square 122.

Based on different characteristics the functions, the functions can be allocated to maximize throughput. For example, if the function represented by trapezoid is a significant computational burden and would bottleneck the execution of the code, execution engine 108 can assign some instances of the parallel code 106 to collection of functions 504 and collection of functions 506. The same can happen with the function represented by pentagon. One instance of the function can be assigned to collection of functions 512. While the overall distribution of the functions in parallel code 106 is no longer even, this can maximize throughput based on the run time of each individual function.

One approach to invoke the function includes applying a Software Development Kit 501 (SDK). A purpose of SDK 501 is to provide a collection of tools, libraries, documentation, code samples, processes, guides, etc., which can create applications integrated into specific third-party platforms, operating systems, frameworks, or programming languages. SDK 501 is generally developed by a third-party. Execution engine 108 exposes the SDK 501 to implement different functions/services. In other words, SDK has a “run” function, which takes in a callback function as an argument (parallel code 106). Execution engine 108 invokes this callback function whenever there is a request on a particular function/service as determined by LLM code generator 104.

Another way to invoke the function that runs on execution engine 108 includes a representational state transfer (REST) API 503 which also allows interfacing with the function/service. The execution engine 108 exposes functions and services via dedicated endpoints. Upon receiving a “POST” request with the proper parameters/inputs, the execution engine 108 processes POST request and returns a response.

To execute requests received on different functions/services (either through SDK or REST API), execution engine 108 internally maintains a queue for each function/service. Whenever a request is received for any function, the request is put at the end of the queue corresponding to the function. Each queue is processed independently to serve function requests. Execution engine 108 maps each request to one of the available copies (“pods”) of the function and executes them on a first-come, first-serve basis. At the time of execution, if the request is no longer valid, e.g. if the sender no longer needs the response, then execution engine 108 automatically removes the request from the queue. By having separate queues and processing requests concurrently, execution engine 108 ensures efficient execution of parallel code 106 on the underlying cluster of computing devices. This is true not only processing requests between various functions, but also within a specific function. Execution engine 108 can map functions/requests to the proper GPU.

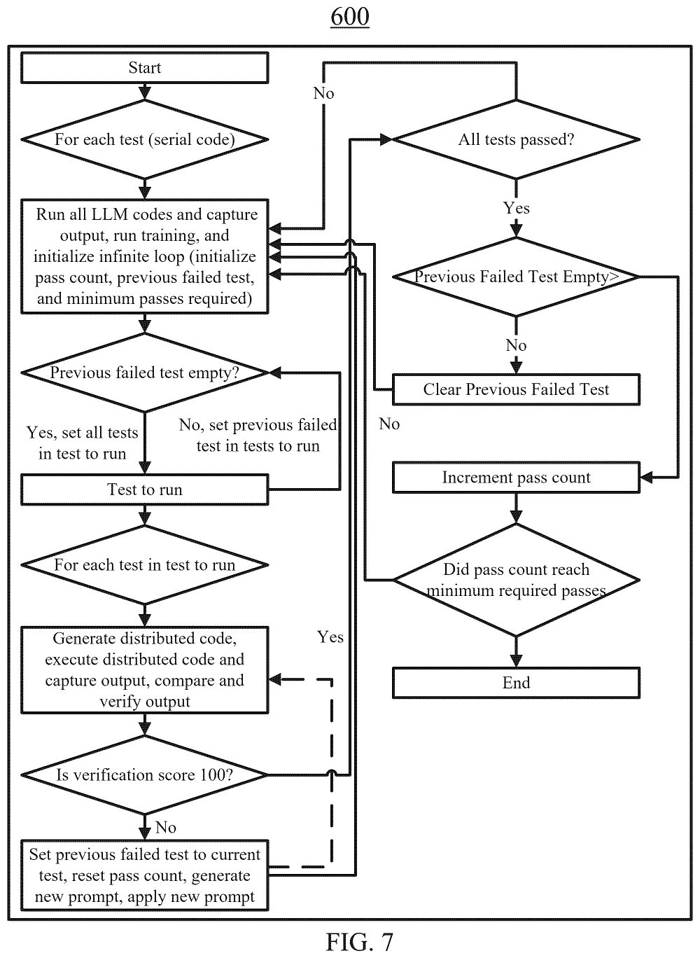

Referring to FIG. 7, a flow diagram is illustrated. The flow diagram depicts the training algorithm 600 which forms parallel code 106 (FIG. 1). At the start of the training, all input serial code 102 (FIG. 2) is run, and the output is captured for further verification purposes. During training, for each input serial code 102 (FIG. 2), parallel code 106 (FIG. 2) is generated initially, and its output is captured. Then, the output is compared to the original input serial code 102 (FIG. 2). If parallel code 106 (FIG. 2) is faster than input serial code 102 (FIG. 2) (performant) and the output matches, then the training proceeds to the next test. If not, then a new prompt 105 (FIG. 2) is generated and applied to LLM code generator 104 (FIG. 2). The failed test is repeated again and again up to a configured maximum number of tries to see if it passes, i.e., the generated parallel code 106 (FIG. 2) is performant and the output matches input serial code 102 (FIG. 2). Whenever a failed test passes, the training starts from the beginning to make sure that the refined system prompt 105 (FIG. 2) has not changed behavior for previously passed tests. This process continues until all tests pass for a minimum configured number of times. Once completed, the training ends and the last system prompt 105 (FIG. 2) is used as the final instructions to generate parallel code 106 (FIG. 2).

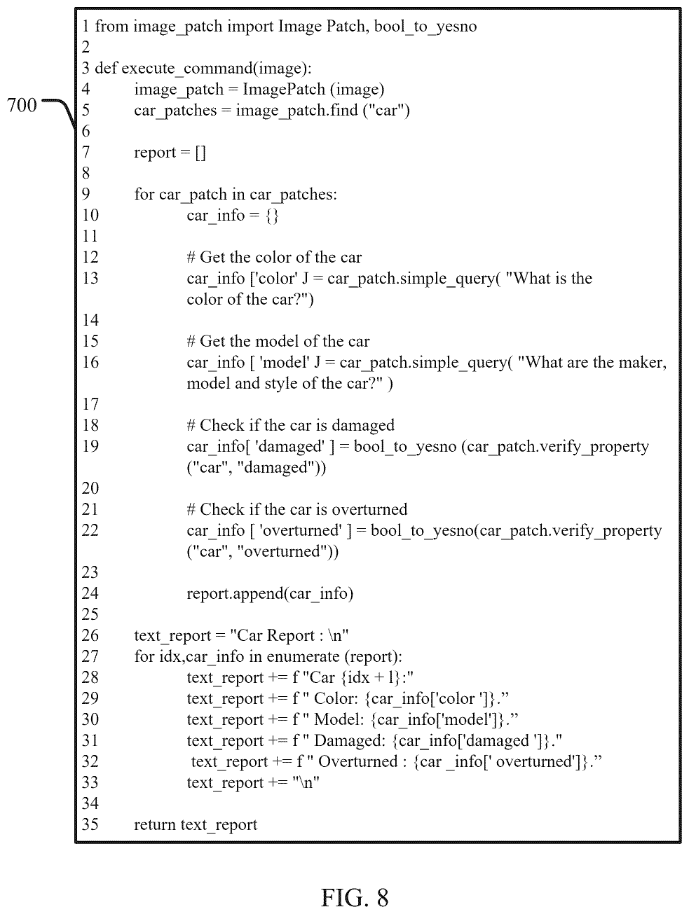

Referring to FIG. 8, an example of serial (monolithic) code 700 is illustrated. Example serial code 700 shows three functions in the program. A first function, find( ), identifies cars in an image and is illustrated on line 5. A second function, simple_query( ), identifies color, model, make, and style of cars in an image and is illustrated in line 13 and line 16. A third function, verify_property( ), checks if a car is damaged or overturned and is illustrated in line 19 and line 22. The code is serial, meaning each is called after one another for all detected cars. The functions within example serial code 700 can be predefined, pre-trained, etc., API calls.

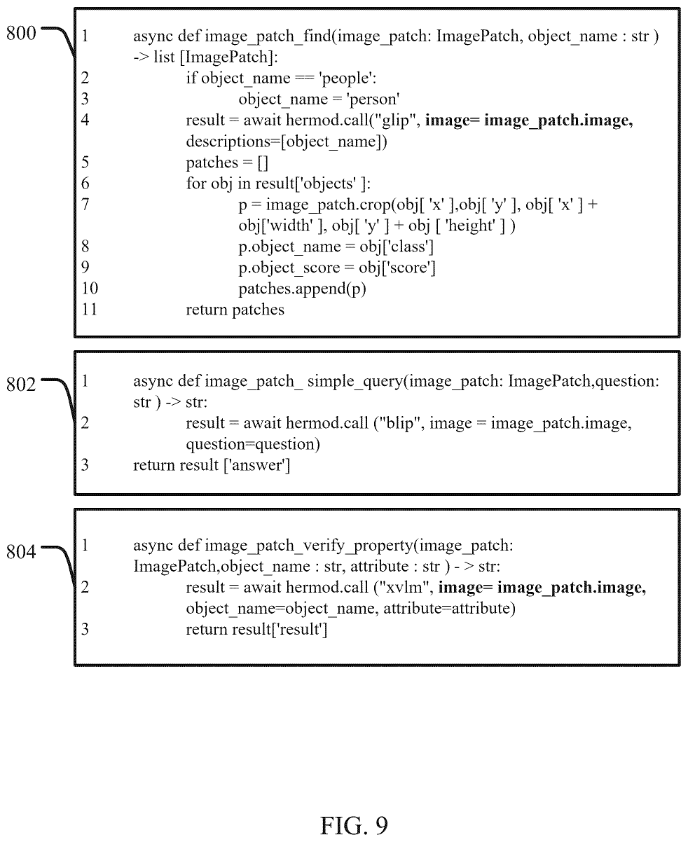

Referring to FIG. 9, examples of parallel code version of example serial code 700 are illustrated. Function 800, function 802, and function 804 employ embodiments of the present invention to take example serial code 700 and form a parallel version. Such that the first function, second function, and third function of FIG. 7 can be performed in parallel or at least partially in parallel. Function 800 correlates to the first function of FIG. 7, function 802 correlates to the second function of FIG. 7, and function 804 correlates to the third function of FIG. 7.

During refactoring of the code (from serial to parallel), specific program semantics are incorporated such that they can be understood, and concurrent execution of API calls can be realized by a runtime. These program semantics are shown in function 800, function 802, and function 804 for find( ), simple_query( ) and verify_property( ), respectively. The API calls are converted into service calls managed by a runtime (execution engine 108 (FIG. 2)). The service calls specify the name of the service as an argument and any associated input data to run the service request. The name of the service is typically the name of the AI model. This model can reside anywhere within the program manager cluster, and execution engine 108 (FIG. 2) will appropriately manage execution on the specific computing device where the AI model is loaded. Execution engine 108 itself exposes an API that can be instructed to be used during parallel code 106 (FIG. 2) generation.

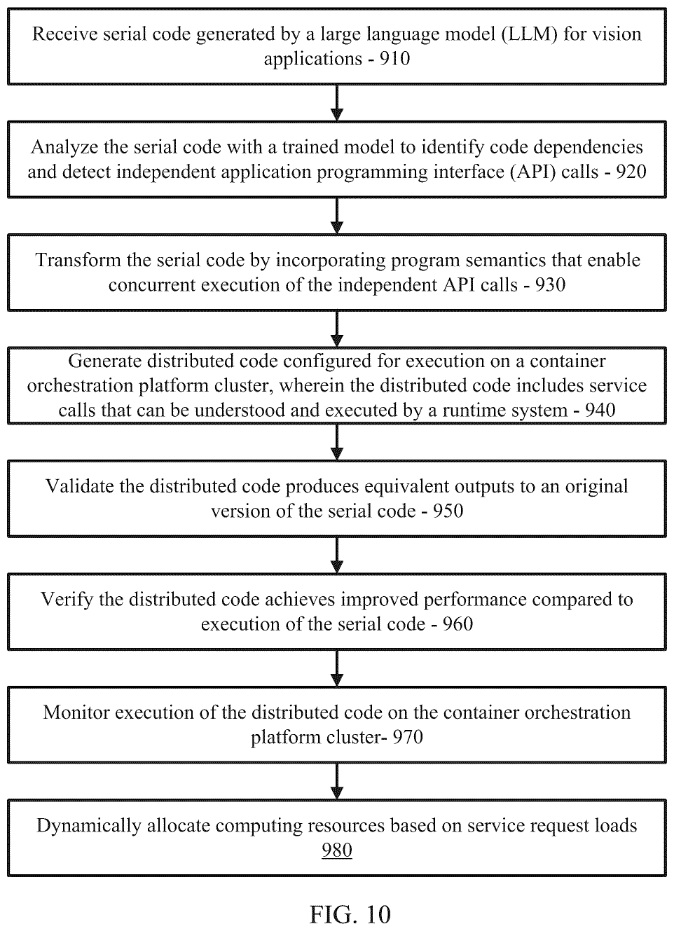

Referring to FIG. 10, a flow diagram demonstrating a method for generating and executing the distributed code is illustrated. In block 910, serial code generated by a large language model (LLM) for vision applications is received. The visual applications can include visual question answering, visual reasoning, image captioning, visual dialog, referring expression comprehension, referring expression generation. Other applications can also include visual grounding, image-text matching, visual entailment, scene graph generation, chart/diagram question answering, visual commonsense reasoning, embodied visual question answering, video question answering, classification, detection, and segmentation. In even further embodiments of the present invention, other applications for the serial code are contemplated.

In block 920, the serial code is analyzed with a trained model to identify code dependencies and detect independent API calls. The independent API calls can be individual instances of when the code calls the given API. The independent API calls can also be a group of instances for the same API calls. For example, while applying the same image processing over several images. Each independent API call instance can be for the specific API on a given image, or calling the API for all the images.

In block 930, the serial code is transformed by incorporating program semantics that enable concurrent execution of the independent API calls. The program semantics can enable the serial code to be run concurrently on multiple computing devices.

In block 940, distributed code configured for execution on a container orchestration platform cluster is generated, wherein the distributed code includes service calls that can be understood and executed by a runtime system. The distributed code can operate the same or very similar to the serial code.

In block 950, the distributed code is validated to ensure the distributed code produces equivalent outputs to an original version of the serial code. In block 960, the distributed code is verified to ensure the distributed code achieves improved performance compared to execution of the serial code. Improved performance can include improved parallelism, runtime, latency, throughput, accuracy, memory usage, computing device usage/downtime, input/output performance, energy efficiency, etc.

In block 970, execution of the distributed code is monitored on the container orchestration platform cluster. The monitoring of the distributed code can be for changes in computing device availability, computing device usage, code priorities, new distributed code, etc. In block 980, computing resources are dynamically allocated based on service request loads.

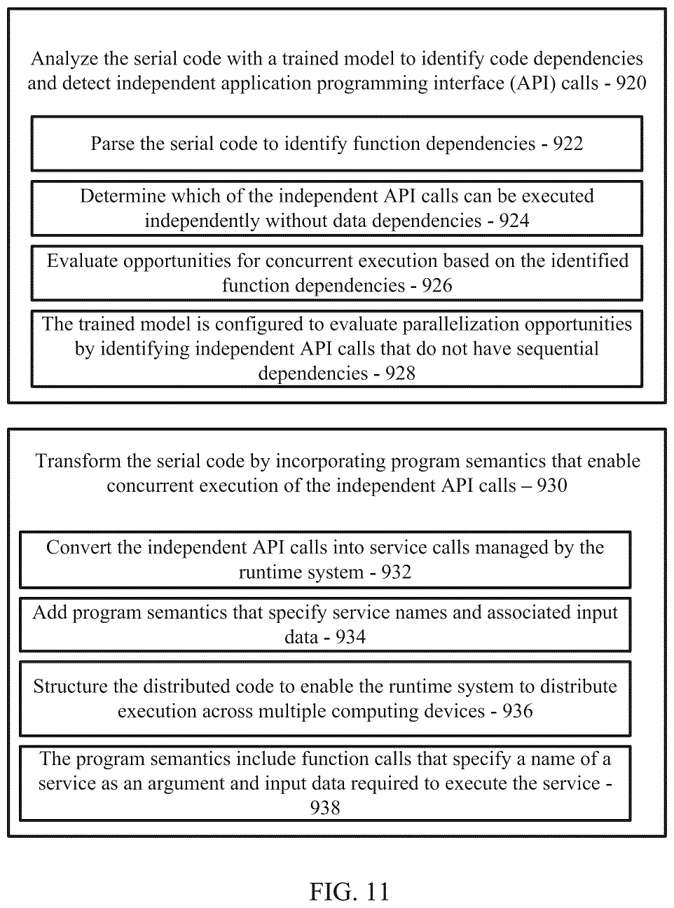

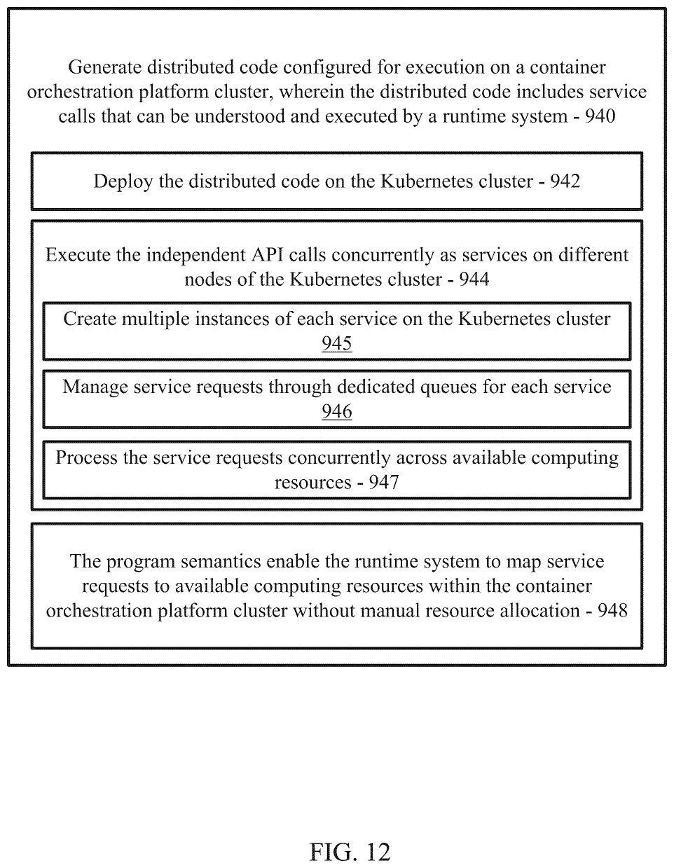

Referring to FIGS. 11-12, block diagrams demonstrating additional embodiments of the present invention are illustrated. Block 920 can include several embodiments. In block 922, the serial code is parsed to identify function dependencies. In block 924, which of the independent API calls can be executed independently without data dependencies is determined. In block 926, opportunities for concurrent execution based on the identified function dependencies are evaluated. In block 928, the trained model is configured to evaluate parallelization opportunities by identifying independent API calls that do not have sequential dependencies.

Block 930 can also include several embodiments. In block 932, the independent API calls are converted into service calls managed by the runtime system. In block 934, program semantics are added that specify service names and associated input data. In block 936, the distributed code is structured to enable the runtime system to distribute execution across multiple computing devices. In block 938, the program semantics includes function calls that specify a name of a service as an argument and input data required to execute the service.

Block 940 can also include several embodiments. In block 942, the distributed code is deployed on the Kubernetes cluster. Other orchestrators are also contemplated. In block 944, the independent API calls are executed concurrently as services on different nodes of the Kubernetes cluster. In block 945, multiple instances of each service are created on the Kubernetes cluster. In block 946, service requests are managed through dedicated queues for each service. In block 947, the service requests are processed concurrently across available computing resources. In block 948, the program semantics enable the runtime system to map service requests to available computing resources within the container orchestration platform cluster without manual resource allocation.

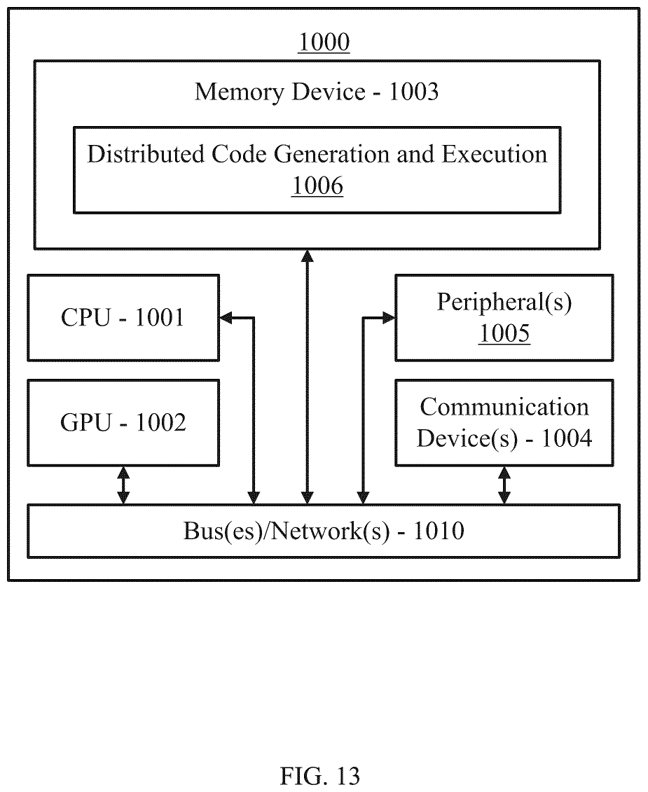

Referring to FIG. 13, a block diagram is shown for an exemplary processing system 1000, in accordance with an embodiment of the present invention. The processing system 1000 includes a set of processing units (e.g., CPUs) 1001, a set of GPUs 1002, a set of memory devices 1003, a set of communication devices 1004, and a set of peripherals 1005. CPUs 1001 can be single or multi-core CPUs. The GPUs 1002 can be single or multi-core GPUs. The one or more memory devices 1003 can include caches, RAMs, ROMs, and other memories (flash, optical, magnetic, etc.). The communication devices 1004 can include wireless and/or wired communication devices (e.g., network (e.g., Wi-Fi®, etc.) adapters, etc.). The peripherals 1005 can include a display device, a user input device, a printer, an imaging device, and so forth. Elements of processing system 1000 are connected by one or more buses or networks (collectively denoted by the figure reference numeral 1010).

In an embodiment of the present invention, memory devices 1003 can store specially programmed software modules to transform the computer processing system into a special purpose computer configured to implement various embodiments of the present invention. In an embodiment, special purpose hardware (e.g., Application Specific Integrated Circuits, Field Programmable Gate Arrays (FPGAs), and so forth) can be used to implement various embodiments of the present invention.

In an embodiment, memory devices 1003 store program code or software 1006 for transforming serial for distributed execution for vision applications. The code generation and execution implement one or more functions of the systems and methods described herein for generating and initiating distributed code. The generation and execution software 1006 includes receiving serial code generated by a LLM for vision applications and analyzing the serial code with a trained model to identify code dependencies and detect independent API calls. Also, software 1006 includes transforming the serial code by incorporating program semantics that enable concurrent execution of the independent API calls and generating distributed code configured for execution on a container orchestration platform cluster, wherein the distributed code includes service calls that can be understood and executed by a runtime system. The memory devices 1003 can store program code for implementing one or more functions of the systems and methods described herein.

Of course, the processing system 1000 may also include other elements (not shown), as readily contemplated by one of skill in the art, as well as omitting certain elements. For example, various other input devices and/or output devices can be included in processing system 1000, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 1000 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 1000.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

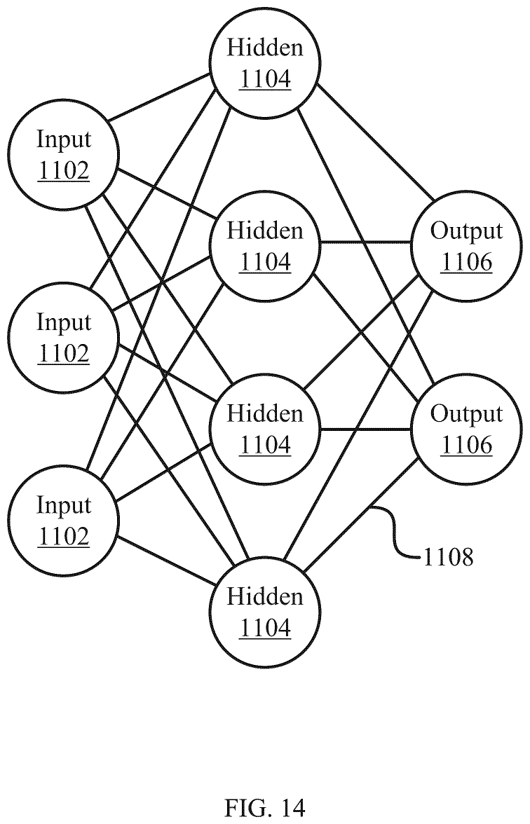

Referring now to FIG. 14, a generalized diagram of a neural network is shown. An artificial neural network (ANN) is an information processing system that is inspired by biological nervous systems, such as the brain. The key element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process. The ANN can identify patterns in text or other forms of communication and form embeddings for future processing. These patterns can relate actions and objects, relate objects to other objects, or actions to other actions. The ANN can identify seemingly unrelated or innocuous patterns or relationships with correlations. The ANN can bound objects into bounding boxes, extract objects from bounding boxes, classify actions, embed objects from features, and extract actions from text, among other capabilities.

Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 1102 that provide information to one or more “hidden” neurons 1104. Connections 1108 between the input neurons 1102 and hidden neurons 1104 are weighted, and these weighted inputs are then processed by the hidden neurons 1104 according to some function in the hidden neurons 1104. There can be any number of layers of hidden neurons 1104, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 1106 accepts and processes weighted input from the hidden neurons 1104.

This represents a “feed-forward” computation, where information propagates from input neurons 1102 to the output neurons 1106. Upon completion of a feed-forward computation, the output is compared to a desired output available from training data. The error relative to the training data is then processed in “backpropagation” computation, where the hidden neurons 1104 and input neurons 1102 receive information regarding the error propagating backward from the output neurons 1106. Once the backward error propagation has been completed, weight updates are performed, with the weighted connections 1108 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each connection 1108 weight may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs.

The ANN can be integrated into distributed code generation and execution by generating the code. LLMs are a type of ANN. LLM code generator 104 (FIG. 2), output verifier 302 (FIG. 4), and prompt generator 304 (FIG. 4). There can be several modules in the ANN that can perform the same, similar, or different tasks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for transforming serial code for distributed execution, comprising:
receiving serial code generated by a large language model (LLM) for vision applications;
analyzing the serial code with a trained model to identify code dependencies and detect independent application programming interface (API) calls;
transforming the serial code by incorporating program semantics that enable concurrent execution of the independent API calls; and
generating distributed code configured for execution on a container orchestration platform cluster, wherein the distributed code includes service calls that can be understood and executed by a runtime system.

2. The method of claim 1, wherein analyzing the serial code comprises:
parsing the serial code to identify function dependencies;
determining which of the independent API calls can be executed independently without data dependencies; and
evaluating opportunities for concurrent execution based on the identified function dependencies.

3. The method of claim 1, wherein transforming the serial code comprises:
converting the independent API calls into service calls managed by the runtime system;
adding program semantics that specify service names and associated input data; and
structuring the distributed code to enable the runtime system to distribute execution across multiple computing devices.

4. The method of claim 1, wherein the program semantics include function calls that specify a name of a service as an argument and input data required to execute the service.

5. The method of claim 1, wherein the container orchestration platform cluster includes a Kubernetes cluster and further comprising:
deploying the distributed code on the Kubernetes cluster; and
executing the independent API calls concurrently as services on different nodes of the Kubernetes cluster.

6. The method of claim 5, wherein executing the independent API calls comprises:
creating multiple instances of each service on the Kubernetes cluster;
managing service requests through dedicated queues for each service; and
processing the service requests concurrently across available computing resources.

7. The method of claim 1, wherein the trained model is configured to evaluate parallelization opportunities by identifying independent API calls that do not have sequential dependencies.

8. The method of claim 1, further comprising:
validating the distributed code produces equivalent outputs to an original version of the serial code; and
verifying the distributed code achieves improved performance compared to execution of the serial code.

9. The method of claim 1, further comprising:
monitoring execution of the distributed code on the container orchestration platform cluster; and
dynamically allocating computing resources based on service request loads.

10. The method of claim 1, wherein the program semantics enable the runtime system to map service requests to available computing resources within the container orchestration platform cluster without manual resource allocation.

11. A system for generating and executing distributed code, comprising:
a processor; and
a memory storing computer-readable instructions that, when executed by the processor, cause the system to:
receive serial code generated by a large language model (LLM) for vision applications;
analyze the serial code with a trained model to identify code dependencies and detect independent application programming interface (API) calls;
transform the serial code by incorporating program semantics that enable concurrent execution of the independent API calls; and
generate distributed code configured for execution on a container orchestration platform cluster, wherein the distributed code includes service calls that can be understood and executed by a runtime system.

12. The system of claim 11, wherein causing the system to analyze the serial code further includes causing the system to:
parse the serial code to identify function dependencies;
determine which of the independent API calls can be executed independently without data dependencies; and
evaluate opportunities for concurrent execution based on the identified function dependencies.

13. The system of claim 11, wherein causing the system to transform the serial code further includes causing the system to:
convert the independent API calls into service calls managed by the runtime system;
add program semantics that specify service names and associated input data; and
structure the distributed code to enable the runtime system to distribute execution across multiple computing devices.

14. The system of claim 11, wherein the program semantics include function calls that specify a name of a service as an argument and input data required to execute the service.

15. The system of claim 11, wherein the container orchestration platform cluster includes a Kubernetes cluster and further causes the system to:
deploy the distributed code on the Kubernetes cluster; and
execute the independent API calls concurrently as services on different nodes of the Kubernetes cluster.

16. The system of claim 15, wherein causing the system to execute the independent API calls further includes causing the system to:
create multiple instances of each service on the Kubernetes cluster;
manage service requests through dedicated queues for each service; and
process the service requests concurrently across available computing resources.

17. The system of claim 11, wherein the trained model is configured to evaluate parallelization opportunities by identifying independent API calls that do not have sequential dependencies.

18. The system of claim 11, further causes the system to:
validate the distributed code produces equivalent outputs to an original version of the serial code; and
verify the distributed code achieves improved performance compared to execution of the serial code.

19. The system of claim 11, further causes the system to:
monitor execution of the distributed code on the container orchestration platform cluster; and
dynamically allocate computing resources based on service request loads.

20. A computer program product comprising a non-transitory computer-readable storage medium containing computer program code, the computer program code when executed by one or more processors causes the one or more processors to perform operations, the computer program code comprising instructions to:
receive serial code generated by a large language model (LLM) for vision applications;
analyze the serial code with a trained model to identify code dependencies and detect independent application programming interface (API) calls;
transform the serial code by incorporating program semantics that enable concurrent execution of the independent API calls; and
generate distributed code configured for execution on a container orchestration platform cluster, wherein the distributed code includes service calls that can be understood and executed by a runtime system.
